(19) United States
(12) Patent Application Publication
(10) Pub. No.: US 2024/0281127 A1
(43) Pub. Date: Aug. 22, 2024

(54) DATA INTERACTION METHOD AND APPARATUS, ELECTRONIC DEVICE AND STORAGE MEDIUM

(71) Applicant: Beijing Zitiao Network Technology Co., Ltd., Beijing (CN)

(72) Inventors: Yepeng CHEN, Beijing (CN); Yi CHEN, Beijing (CN); Hantong XU, Beijing (CN); Yibo XU, Beijing (CN)

(21) Appl. No.: 18/569,978

(22) PCT Filed: Aug. 25, 2022
(86) PCT No.: PCT/CN2022/114720

§ 371 Date: Dec. 13, 2023

(30) Foreign Application Priority Data
Sep. 7, 2021 (CN) 202111045911.2

(51) Int. Cl. G06F 3/04845

(52) U.S. Cl. CPC G06F 3/04845

(57) ABSTRACT

The application discloses a data interaction method and apparatus, electronic device and storage medium. The method includes displaying a video playing page displaying a shoe try-on control associated with target shoes; in response to a triggering operation on the shoe try-on control, starting a terminal camera to enter a try-on page of the target shoes, and controlling a first shoe model of the target shoes with a preset size to be worn on user's feet shot by the camera in the try-on page; and in response to a triggering operation for a target size in the try-on page, controlling a second shoe model of the target shoes with the target size to replace the first shoe model to be worn on the user's feet, wherein when the target size is larger than the preset size, the second shoe model is larger than the first shoe model.

This application claims priority to Chinese Patent Application 202111045911.2, entitled “Data interaction method and device, electronic equipment and storage medium” filed on Sep. 7, 2021, which is incorporated in this application by reference in its entirety.

### TECHNICAL FIELD

The present disclosure relates to the technical field of information, and particularly relates to a data interaction method and apparatus, an electronic device and a storage medium.

### BACKGROUND

With the rapid development of mobile terminal technology and mobile network technology, shopping online anytime and anywhere has become a trend.

However, when users purchase clothing or shoes online, they cannot try on and also cannot choose the suitable size.

### SUMMARY

In order to solve or at least partially solve the technical problem above, an embodiment of the present disclosure provides a data interaction method and apparatus, an electronic device and a storage medium, aiming to achieve the purpose of facilitating users to conveniently and accurately determine the suitable shoe size.

In a first aspect, an embodiment of the present disclosure provides a shoe try-on method based on AR (Augmented Reality), which includes:
displaying a video playing page, the video playing page displaying a shoe try-on control associated with target shoes;
in response to a triggering operation on the shoe try-on control, starting a terminal camera to enter a try-on page of the target shoes, and controlling a first shoe model of the target shoes with a preset size to be worn on user's feet shot by the camera in the try-on page; and
in response to a triggering operation for a target size in the try-on page, controlling a second shoe model of the target shoes with the target size to replace the first shoe model to be worn on the user's feet;
wherein when the target size is larger than the preset size, the second shoe model is larger than the first shoe model.

In a second aspect, an embodiment of the present disclosure also provides a data interaction apparatus, which includes:
a first display module, configured to display a video playing page, the video playing page displaying a shoe try-on control associated with target shoes;
a first try-on module, configured to in response to a triggering operation on the shoe try-on control, start a terminal camera to enter a try-on page of the target shoes, and control a first shoe model of the target shoes with a preset size to be worn on user's feet shot by the camera in the try-on page; and
a second try-on module, configured to in response to a triggering operation for a target size in the try-on page, control a second shoe model of the target shoes with the target size to replace the first shoe model to be worn on the user's feet;
wherein when the target size is larger than the preset size, the second shoe model is larger than the first shoe model.

In a third aspect, an embodiment of the present disclosure also provides an electronic device, which includes:
one or more processors; and
a storage apparatus for storing one or more programs;
wherein the one or more programs, when executed by the one or more processors, cause the one or more processors to implement the data interaction method as described above.

In a forth aspect, an embodiment of the present disclosure also provides a computer readable storage medium, storing a computer program thereon, wherein the program, when executed by a processor, implements the data interaction method as described above.

Compared with related technologies, the technical solution provided by the embodiment of the present disclosure at least has the following advantages:

according to the data interaction method provided by the embodiment of the present disclosure, when switching the size of the tried-on shoes, users can change the size of a shoe mold worn on the feet, then the shoe mold worn on the user's feet can be changed along with the size switching operation triggered by the user, thus the users can conveniently choose the suitable size according to the size of the shoe mold worn on the feet, and the purpose of facilitating the users to conveniently and accurately determine the suitable shoe size is achieved.

### BRIEF DESCRIPTION OF THE DRAWINGS

The above and other features, advantages, and aspects of each embodiment of the present disclosure will become more apparent in conjunction with the accompanying drawings and the following specific embodiments. In the accompanying drawings, identical or similar reference numerals represent identical or similar elements. It is to be understood that the accompanying drawings are illustrative, and the original and elements may not necessarily be drawn to scale.

FIG. 1 is a flowchart of a data interaction method according to an embodiment of the present disclosure;

FIG. 2 is an interface schematic diagram of displaying an AR shoe dry-on control on a video playing page according to an embodiment of the present disclosure;

FIG. 3 is a schematic diagram of a curved interface according to an embodiment of the present disclosure;

FIG. 4 is a schematic diagram of a try-on page according to an embodiment of the present disclosure;

FIG. 5 is a schematic diagram of a try-on page according to an embodiment of the present disclosure;

FIG. 6 is a schematic diagram of a try-on page according to an embodiment of the present disclosure;

FIG. 7 is a flowchart of a data interaction method according to an embodiment of the present disclosure;

FIG. 8 is a schematic diagram of a try-on page according to an embodiment of the present disclosure;

FIG. 9 is a structural schematic diagram of a data interaction apparatus according to an embodiment of the present disclosure; and

FIG. 10 is a structural schematic diagram of an electronic device according to an embodiment of the present disclosure.

### DETAILED DESCRIPTION

The embodiments of the present disclosure will be described in more detail below with reference to the accompanying drawings. Although some embodiments of the present disclosure are shown in the accompanying drawings, it is to be understood that the present disclosure may be implemented in various forms and may not be construed as limited to the embodiments described here. On the contrary, these embodiments are provided for a more thorough and complete understanding of the present disclosure. It is to be understood that the accompanying drawings and embodiments disclosed in the present disclosure are only for illustrative purposes and are not intended to limit the scope of protection of the present disclosure.

It is to be understood that the steps in embodiments of the present disclosure may be performed in different sequences, and performed in parallel. Further, the embodiments may include additional steps and/or omit to perform the illustrated steps. The scope of the present disclosure is not limited in this respect.

The term “including/comprising” and its variations as used herein mean openly including, i.e. “including but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms are given in the following description.

It is to be noted that the concepts of “first”, “second”, etc. mentioned in the present disclosure are only used for distinguishing different apparatuses, modules or units, and are not to limit the function performing sequence or interdependence of these apparatuses, modules or units.

It is to be noted that the modifications of “one” and “plurality” mentioned in the present disclosure are schematic rather than restrictive, and those skilled in the art should understand that unless otherwise expressly indicated in the context, it should be understood as “one or more”.

The names of messages or information interacted between a plurality of apparatuses in the embodiments of the present disclosure are for illustrative purposes only rather than for limitation to the scope of such messages or information.

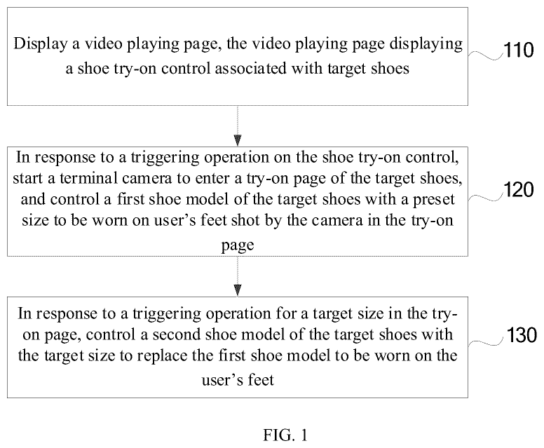

FIG. 1 is a flowchart of a data interaction method according to an embodiment of the present disclosure. The method is suitable for a scene that a user virtually tries on shoes when purchasing online, and chooses suitable size according to the virtual try-on effect. The method may be executed by a data interaction apparatus; the apparatus may implement the method by means of software and/or hardware; and the apparatus may be configured in an electronic device, such as a display terminal, specifically including but being not limited to electronic devices with display screens and cameras, such as a smart phone, a palm computer, a tablet computer, a portable wearable device, and a smart home device (like a table lamp).

As shown in FIG. 1, the method may include the following specific steps:

Step 110: Display a video playing page, the video playing page displaying a shoe try-on control associated with target shoes.

Specifically, the user may perform online shopping by means of an online shopping mall or small video recommendation and the like. If online shopping is implemented by means of the online shopping mall, the user usually enters a page of the online shopping mall, and browses specific commodities such as shoes on the page of the online shopping mall; an AR shoe try-on control may be set on the detail page of the commodities, so that the user can trigger the AR shoe try-on control to enter a try-on page of a certain pair of specific shoes. If online shopping is implemented by means of small video recommendation, the user may usually see a short-form video with goods when scrolling through the short-form videos such as a Feed stream, and the playing page of this short-form video will introduce the specific commodities such as shoes, and display the AR shoe try-on control, and the user can trigger the AR shoe try-on control on the playing page of the short-form video to enter the shoe try-on page currently displayed by the short-form video.

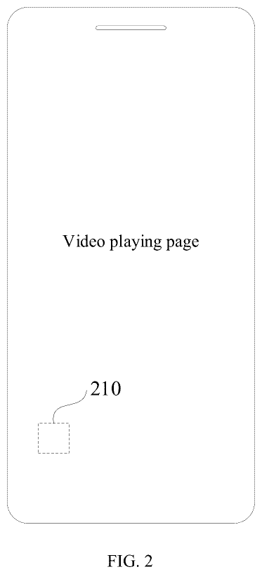

Exemplarily, as shown in FIG. 2 that is an interface schematic diagram of displaying an AR (Augmented Reality) shoe try-on control on a video playing page, the content played on the video playing page may be a video of a shopping streamer introducing target shoes, and the AR shoe try-on control 210 is displayed on the video playing page; and the user can trigger the AR shoe try-on control 210 to enter the try-on page, specifically a page for trying on the target shoe currently introduced by the shopping streamer. Or a list of multiple shoes is displayed on the video playing page, each shoe is associated with a corresponding shoe try-on control, and the user can trigger the try-on control to enter the try-on page of the target shoes; and the user can only try on the target shoes in the try-on page, and other shoes except the target shoes cannot be tried on.

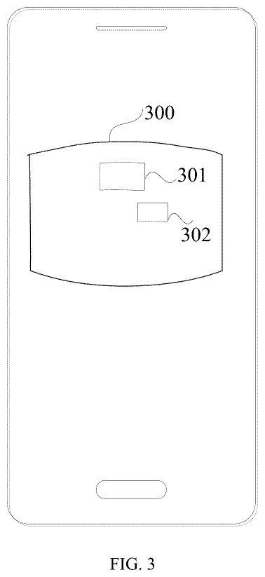

Further, in order to obtain better visual perception and shopping immersion, the list of shoes may be displayed by means of a curved surface interface, as shown in FIG. 3 that is a schematic diagram of a curved surface interface, it includes a curved surface interface 300, and the list of the shoes is displayed in the curved surface interface 300, specifically including an image 301 of the shoes, and a try-on control 302 associated with the image 301 of the shoes; and the user can trigger the try-on control 302 to enter the try-on pages of the shoes represented by the image 301. The user may screen left or right to switch the list of the shoes to view the shoes of other styles.

Step 120: In response to a triggering operation on the shoe try-on control, start a terminal camera to enter the try-on page of the target shoes, and control a first shoe model of the target shoes with a preset size to be worn on user's feet shot by the camera in the try-on page.

When the user triggers the AR shoe try-on control, the system will automatically start the terminal camera, and the user's feet can be shot through the camera; when the user enters the try-on page, the system will default to wear the first shoe model of the target shoes with the preset size on the user's feet shot by the camera in real time, thus the user can see the try-on effect from a display screen of own terminal; and the user's feet may move at will, and the shoe model will always keep the effect of being worn on the user's feet along with movement of the feet. The preset size is usually the size of the largest number of purchased people, for example, the preset size of male shoes is usually 42, and the preset size of female shoes is usually 37. If the user is not satisfied with the default preset size of the system, the size can be automatically switched, and the user can try on to gain the try-on effect of the suitable size.

Further, the shoe model refers to a three-dimensional model of the shoes; the three-dimensional model of the shoes may be stored in a server in a form of a file package; and when a client needs to call the three-dimensional model of the shoes, the corresponding three-dimensional model is acquired from the server. In some embodiments, in order to realize the virtual try-on function at the client, the file package including the three-dimensional model of the shoes is pre-stored in the server working in cooperation with the client; the file package may further include at least one of the following resources: a map sub-file of the shoes, a model sub-file of the shoes, a material resource file, a shank model, a rendering assembly, a pose assembly, and a reference relationship between the rendering component and each file, for example, the material resource file references the map sub-file, the rendering assembly references the model sub-file and the material resource file, and the pose assembly references a foot detection algorithm, thus the server cooperates with the client to realize the virtual try-on function at the client based on the file package. Specifically, when the client performs virtual try-on, the foot position and pose of the user may be acquired in real time through the pose assembly, and the rendering assembly renders the three-dimensional model of the shoes according to the foot position and pose of the user.

Step 130: In response to a triggering operation for a target size in the try-on page, control a second shoe model of the target shoes with the target size to replace the first shoe model to be worn on the user's feet.

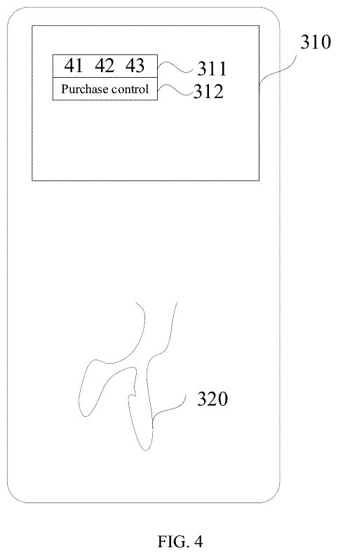

If the target size is larger than the preset size, the second shoe model is larger than the first shoe model. Exemplarily, as shown in FIG. 4 that is a schematic diagram of a try-on page, associated information 310 of the target shoes which are tried on currently and user's feet 320 shot in real time are displayed in the try-on page; the associated information 310 specifically includes a size tag 311 of the target shoes and a purchase control 312; and the user can trigger the specific size tag 311 to switch the try-on size. For example, when the user enters the try-on page, the system will default to wear the 42-size first shoe model on the user's feet, the user may feel that the size is slightly large, and can switch the try-on size; for example, the user triggers a 41-size tag, the 41-size second shoe model will be controlled to be worn on the user's feet, the 41-size first shoe model looks smaller than the 42-size second shoe model, and the user can determine which size is more suitable through visual perception, so that the purpose of facilitating the user to choose a suitable size is achieved.

The user may achieve the purpose of one-key purchase by triggering the purchase control 312 in the try-on page, and thus the user can conveniently purchase satisfied shoes. Generally, the method further includes: in response to a triggering operation on an acquisition control in the try-on page, displaying an acquisition page of the target shoes, thereby enabling the user to acquire the target shoes based on the acquisition page. The acquisition control is the purchase control 312 shown in FIG. 4.

In order to further facilitate the user to choose the suitable size, in one embodiment, the shoe try-on method further includes: in response to a triggering operation on a transparency adjusting control in the try-on page, controlling a transparency of the first shoe mold or the second shoe mold worn on the user's feet, thereby exposing the user's feet covered by the first shoe mold or the second shoe mold. It is to be understood that if the current user's feet wear the first shoe mold, and the user triggers the transparency adjusting control, the transparency of the first shoe mold will be controlled to be changed, and thus the user's feet covered by the first shoe mold can be exposed; and if the current user's feet wear the second shoe mold, and the user triggers the transparency adjusting control, the transparency of the second shoe mold will be controlled to be changed, and thus the user's feet covered by the second shoe mold can be exposed. By adjusting the transparency of the shoe mold covering the user's feet, the user can conveniently and visually see the fit degree between the shoe mold and the feet, and thus the user can be further assisted to choose the suitable size.

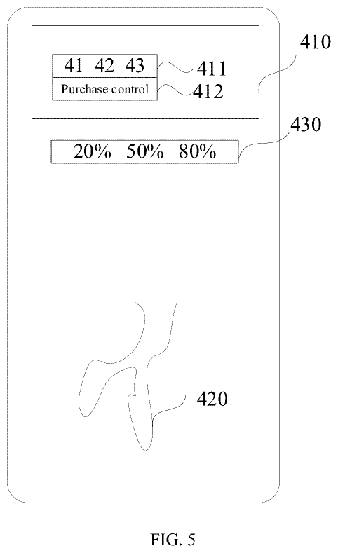

The transparency adjusting control may be realized in various ways, as shown in FIG. 5 that is a schematic diagram of a try-on page, associated information 410 of the target shoes which are tried on currently and user's feet 420 shot in real time are displayed in the try-on page; the associated information 410 specifically includes a size tag 411 of the target shoes and a purchase control 412; it further includes a transparency adjusting control 430, and the transparency adjusting control 430 includes selectable tags which are given according to transparency percentages, such as 20%, 50%, 80% and other transparency percentage tags; under the 80% transparency, the complete feet may be seen clearly basically; under the 50% transparency, the front soles may be seen clearly, and the rear soles are not exposed completely; and the user may select the specific transparency percentage as required.

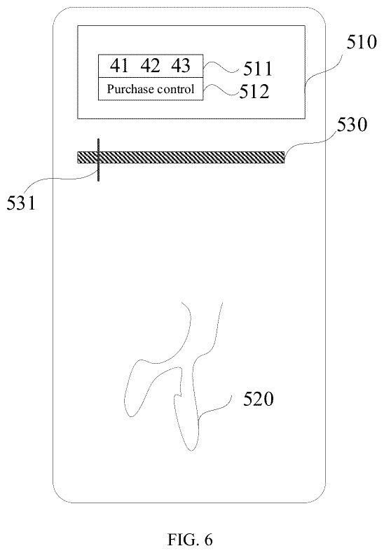

In another embodiment, the transparency adjusting control may also be in a sliding rod form, as shown in FIG. 6 that is a schematic diagram of a try-on page, associated information 510 of the target shoes which are tried on currently and user's feet 520 shot in real time are displayed in the try-on page; the associated information 510 specifically includes a size tag 511 of the target shoes and a purchase control 512; it further includes a transparency adjusting control 530, and the transparency adjusting control 530 specifically is a transparency adjusting sliding rod; and the user can drag an adjusting pointer 531 on the sliding rod to achieve the purpose of adjusting the transparency of the shoe mold worn on the user's feet. Generally, the transparency adjusting control includes the transparency adjusting sliding rod; in response to the triggering operation on the transparency adjusting control, controlling the transparency of the first shoe mold or the second shoe mold worn on the user's feet includes: determining target transparency according to a position of an adjusting pointer on the transparency adjusting sliding rod; and controlling the transparency of the shoe mold worn on the user's feet to be the target transparency.

According to the data interaction method provided by the embodiment of the present disclosure, when switching the size of the tried-on shoes, users can change the size of a shoe mold worn on the feet, then the shoe mold worn on the user's feet can be changed along with the size switching operation triggered by the user, thus the users can conveniently choose the suitable size according to the size of the shoe mold worn on the feet, and the purpose of facilitating the users to conveniently and accurately determine the suitable shoe size is achieved.

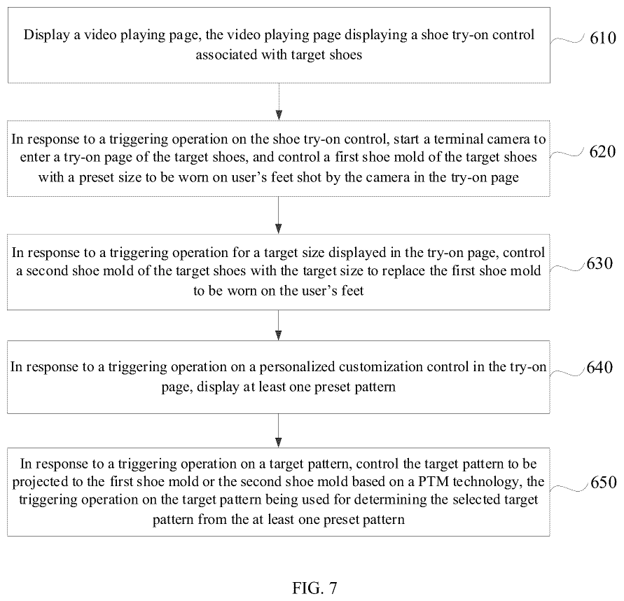

FIG. 7 is a flow schematic diagram of a data interaction method according to an embodiment. On the basis of the embodiments above, in this embodiment, the function of supporting self-definition of patterns on the shoe mold is added, and therefore the user can achieve the purpose of self-defining the patterns on the shoes according to the preference.

As shown in FIG. 7, the data interaction method includes the following steps:

Step 610: Display a video playing page, the video playing page displaying a shoe try-on control associated with target shoes.

Step 620: In response to a triggering operation on the shoe try-on control, start a terminal camera to enter the try-on page of the target shoes, and control a first shoe model of the target shoes with a preset size to be worn on user's feet shot by the camera in the try-on page.

Step 630: In response to a triggering operation for a target size displayed in the try-on page, control a second shoe mold of the target shoes with the target size to replace the first shoe mold to be worn on the user's feet.

When the target size is larger than the preset size, the second shoe mold is larger than the first shoe mold.

Step 640: In response to a triggering operation on a personalized customization control in the try-on page, display at least one preset pattern.

Step 650: In response to a triggering operation on a target pattern, control the target pattern to be projected to the first shoe mold or the second shoe mold based on a PTM (projection Texture Mapping) technology, the triggering operation on the target pattern being used for determining the selected target pattern from the at least one preset pattern.

The PTM technology is used for mapping a texture to an object, just like projecting a slide to a wall. According to this embodiment, the PTM technology is applied to an AR shoe try-on scene, the user may project a favorite pattern to the shoe mold in the shoe try-on process, thus the effect of printing the pattern on the shoe mold can be seen in advance, moreover, the effect after the user wears the shoe mold on the feet can also be seen, and the use experience of the user can be improved. The preset pattern may be provided by the system, and may also be collected by the user, for example, it is supported to import the preset pattern from a photo album by the user. The user may also edit the pattern online through tools such as a paintbrush, for example, adjusting the color matching of the pattern, and therefore real personalized customization is achieved.

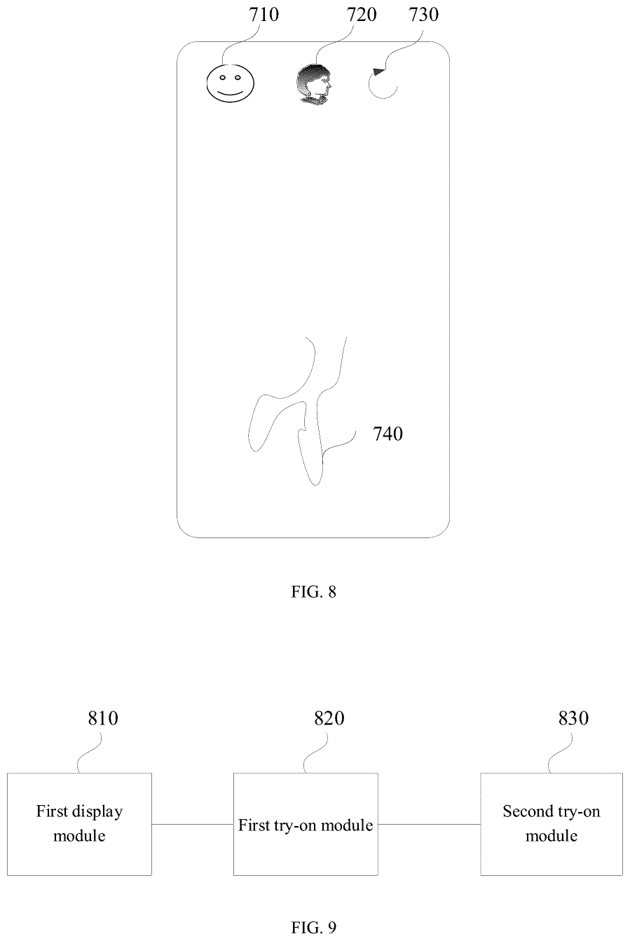

Exemplarily, as shown in FIG. 8 that is a schematic diagram of a try-on page; it includes three preset patterns which are a first preset pattern 710, a second preset pattern 720 and a third preset pattern 730, and user's feet 740 shot by the camera in real time. If the user triggers the first preset pattern 710, the first preset pattern will be controlled to be projected to the shoe mold worn on the user's feet; and if the user triggers the second preset pattern 720, the second preset pattern will be controlled to be projected to the shoe mold worn on the user's feet. Further, the user may also drag the preset patterns to change a position of the preset pattern on the shoe mold, or edit the preset pattern online through the editing tool, for example, changing the color matching of the pattern.

Generally, the shoe try-on method further includes: in response to a preset operation, adjusting a projection position of the target pattern on the first shoe mold or second shoe mold; and in response to a triggering operation on an editing control, displaying an editing page of the target pattern, thereby enabling the user to edit the target pattern based on the editing page.

Further, in some embodiments, the user is supported to share the personalized customized shoes, or try-on video; specifically, in response to a triggering operation on a release control in the try-on page, the first shoe mold or the second shoe mold projected with the target pattern is released as a work, or a recorded video that the user tries on the first shoe mold or the second shoe mold with the target pattern is released as a work. Therefore, the personalized customized shoes may be seen at other clients, other users can make praise, comments and the like, and as a result, the purpose of collecting essential designs of people is achieved, and the shoes with the praise number reaching a threshold value may be produced in batches or pre-sold and the like.

FIG. 9 is a structural schematic diagram of a data interaction apparatus according to an embodiment of the present disclosure. As shown in FIG. 9, the data interaction apparatus specifically includes: a first display module 810, a first try-on module 820, and a second try-on module 830.

The first display module 810 is configured to display a video playing page, the video playing page displaying a shoe try-on control associated with target shoes; the first try-on module 820 is configured to in response to a triggering operation on the shoe try-on control, start a terminal camera to enter the try-on page of the target shoes, and control a first shoe model of the target shoes with a preset size to be worn on user's feet shot by the camera in the try-on page; the second try-on module 830 is configured to in response to a triggering operation for a target size in the try-on page, control a second shoe model of the target shoes with the target size to replace the first shoe model to be worn on the user's feet, wherein if the target size is larger than the preset size, the second shoe model is larger than the first shoe model.

Optionally, the apparatus further includes: a control module, configured to in response to a triggering operation on a transparency adjusting control in the try-on page, control a transparency of the first shoe mold or the second shoe mold worn on the user's feet, thereby exposing the user's feet covered by the first shoe mold or the second shoe mold.

Optionally, transparency adjusting control includes a transparency adjusting sliding rod; and the control module is specifically configured to determine target transparency according to a position of an adjusting pointer on the transparency adjusting sliding rod; and control the transparency of the shoe mold worn on the user's feet to be the target transparency.

Optionally, the apparatus further includes: a second display module, configured to in response to a triggering operation on a personalized customization control in the try-on page, display at least one preset pattern; a projection module, configured to in response to a triggering operation on a target pattern, control the target pattern to be projected to the first shoe mold or the second shoe mold based on a PTM technology, the triggering operation on the target pattern being used for determining the selected target pattern from the at least one preset pattern.

Optionally, the apparatus further includes: an adjusting module, configured to in response to a preset operation, adjust a projection position of the target pattern on the first shoe mold or second shoe mold; and an editing module, configured to in response to a triggering operation on an editing control, display an editing page of the target pattern, thereby enabling the user to edit the target pattern based on the editing page.

Optionally, the apparatus further includes: a releasing module, configured to in response to a triggering operation on a release control in the try-on page, release the first shoe mold or the second shoe mold projected with the target pattern as a work.

Optionally, the apparatus further includes: an acquisition module, configured to in response to a triggering operation on an acquisition control in the try-on page, display an acquisition page of the target shoes, thereby enabling the user to acquire the target shoes based on the acquisition page. According to the data interaction method provided by the embodiment of the present disclosure, when switching the size of the tried-on shoes, users can change the size of a shoe mold worn on the feet, then the shoe mold worn on the user's feet can be changed along with the size switching operation triggered by the user, thus the users can conveniently choose the suitable size according to the size of the shoe mold worn on the feet, and the purpose of facilitating the users to conveniently and accurately determine the suitable shoe size is achieved.

The data interaction apparatus according to the embodiment of the present disclosure can be used for implementing the steps in the data interaction method according to the embodiment of the present disclosure, and the implementing steps and the beneficial effects are not described any more herein.

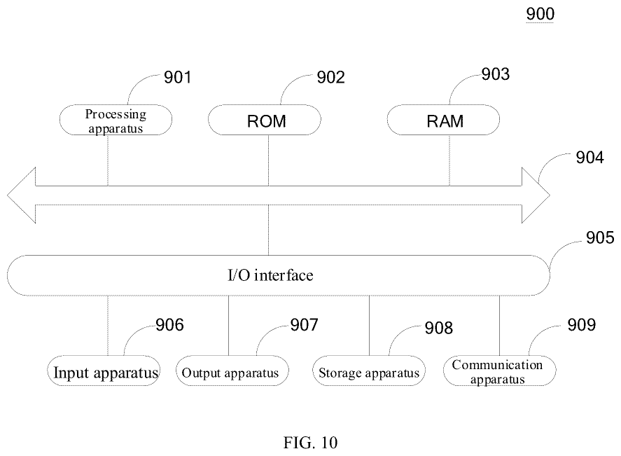

FIG. 10 is a structural schematic diagram of an electronic device according to an embodiment of the present disclosure. FIG. 10 shows a structural schematic diagram suitable for realizing an electronic device 900 according to an embodiment of the present disclosure. The electronic device 900 according to the embodiment of the present disclosure may include but be not limited to mobile terminals such as mobile terminals like mobile phones, notebook computers, digital broadcast receivers, PDAs (Personal Digital Assistants), PADs (Tablet Personal Computers), PMPs (Portable Multimedia Players), vehicle-mounted terminals (such as vehicle-mounted navigation terminals), and wearable electronic devices, and fixed terminals like digital TVs, desktop computers, and smart home devices. The electronic device shown in FIG. 10 is only an example and should not impose any limitations on the functionality or scope of use of the embodiment of the present disclosure.

As shown in FIG. 10, the electronic device 900 may include a processing apparatus (such as a central processing unit, and a graphic processor) 901, and the processing device may execute various proper actions and processing according to programs stored in a read-only memory (ROM) 902 or programs loaded into a random access memory (RAM) 903 from a storage apparatus 908 so as to achieve the method according to the embodiment of the present disclosure. Various programs and data for the operation of the electronic apparatus 900 are further stored in the RAM 903. The processing apparatuses 901, the ROM 902 and the RAM 903 are interconnected through a bus 904. An input/output (I/O) interface 905 is also connected to the bus 904.

Generally, the following apparatuses may be connected to an I/O interface 905: an input apparatus 906 including a touch screen, a touch pad, a keyboard, a mouse, a camera, a microphone, an accelerometer, a gyroscope and the like, an output apparatus 907 including a liquid crystal display (LCD), a loudspeaker, a vibrator and the like, a storage device 908 including a magnetic tape, a hard disk and the like, and a communication apparatus 909. The communication apparatus 909 may allow the electronic device 900 to perform wireless or wired communication with other devices to exchange data. Although FIG. 10 illustrates the electronic device 900 with various apparatuses, it is to be understood that it is not required to implement or provide all the shown apparatuses. More or fewer devices can be alternatively implemented or provided.

Particularly, according to the embodiment of the present disclosure, the above process described with reference to the flowchart may be implemented as a computer software program. For example, an embodiment of the present disclosure includes a computer program product which includes a computer program loaded on a non-transient computer readable medium, the computer program including a program code for executing the method shown by the flowchart, so that the above method is implemented. In this embodiment, the computer program may be downloaded and installed from a network through the communication apparatus 909, or installed from the storage apparatus 908, or installed from the ROM 902. When the computer program is executed by the processing apparatus 901, the above functions defined in the method according to the embodiment of the present disclosure are executed.

It is to be noted that a computer readable medium according to the present disclosure may be a computer readable signal medium or a computer readable storage medium or any combination of the two. The computer readable storage medium may be, for example, but not limited to, an electrical, magnetic, optical, electromagnetic, infrared, or semiconductor system, apparatus or device, or any combination of the above. More specific examples of computer readable storage media may include, but be not limited to, electrical connectors having one or more conductors, a portable computer disk, a hard disk, a Random Access Memory (RAM), a Read-Only Memory (ROM), an Erasable Programmable Read-Only Memory (EPROM or flash memory), an optical fiber, a portable Compact Disk Read-Only Memory (CD-ROM), an optical storage device, a magnetic storage device, or any suitable combination of the above. In the present disclosure, the computer readable storage medium may be any tangible medium containing or storing a program that may be used by or in combination with an instruction execution system, apparatus or device. In the present disclosure, the computer readable signal medium may include a data signal that propagates in a baseband or as part of a carrier, and the data signal carries computer readable program code. The propagated data signal may take a variety of forms, including, but being not limited to, an electromagnetic signal, an optical signal, or any suitable combination of the above. The computer readable signal medium may also be any computer readable medium other than a computer readable storage medium that may send, propagate, or transmit a program for use by or in combination with an instruction execution system, apparatus or device. The program code in on the computer readable medium may be transmitted with any suitable medium, including, but being not limited to, an electrical wire, an optical cable, an RF (radio frequency) or the like, or any suitable combination of the above.

In some embodiments, the client, and the server may communicate using any currently known or future developed network Protocol, such as HTTP (HyperText Transfer Protocol), and may interconnect with digital data communications (e.g., communication networks) of any form or medium. Examples of communication networks include local area networks (“LANs”), wide area networks (“WANs”), Internet networks (e.g., the Internet) and end-to-end networks (e.g., ad hoc end-to-end networks), and any currently known or future developed network.

The abovementioned computer readable medium may be contained in the electronic device, and may also exist independently without being assembled in the electronic device.

The abovementioned computer readable medium carries one or more programs, and when the one or more programs are executed by the electronic device, cause the electronic device to:
display a video playing page, the video playing page displaying a shoe try-on control associated with target shoes; in response to a triggering operation on the shoe try-on control, start a terminal camera to enter a try-on page of the target shoes, and control a first shoe model of the target shoes with a preset size to be worn on user's feet shot by the camera in the try-on page; and in response to a triggering operation for a target size in the try-on page, control a second shoe model of the target shoes with the target size to replace the first shoe model to be worn on the user's feet, wherein when the target size is larger than the preset size, the second shoe model is larger than the first shoe model.

Optionally, when one or more programs are executed by the electronic device, the electronic device can also execute other steps described in the above embodiment.

The computer program code for executing the operations of the present disclosure may be written in one or more programming languages or a combination thereof, the programming languages including, but being not limited to object-oriented programming languages such as Java, Smalltalk and C++, and also including conventional process programming languages such as a “C” language or similar programming languages. The program code may be completely executed on a user computer, partially executed on the user computer, executed as a separate software package, partially executed on the user computer, partially executed on a remote computer, or completely executed on the remote computer or a server. In a case involving the remote computer, the remote computer may be connected to the user computer through any kind of networks including a Local Area Network (LAN) or a Wide Area Network (WAN), or may be connected to an external computer (for example, the remote computer is connected through the Internet by utilizing an Internet service provider).

The flowchart and the block diagram in the accompanying drawings illustrate the architecture, functions and operations which can be possibly realized according to the systems, methods and computer program products according to various embodiments of the present disclosure. In this regard, each block in the flowchart or the block diagram may represent a module, a program segment or a part of code; and the module, the program segment or the part of code contains one or more executable instructions for realizing specified logic functions. It is to be noted that in some alternative embodiments, the functions marked in the blocks may also occur in a different order than the order marked in the accompanying drawing. For example, two blocks represented in succession may be executed substantially in parallel, and sometimes may also be executed in an opposite order depending on the functions involved. It is also to be noted that each block in the block diagram and/or the flowchart and the combination of the blocks in the block diagram and/or the flowchart may be implemented by a dedicated hardware-based system for executing specified functions or operations, or may be implemented by a combination of dedicated hardware and computer instructions.

The unit described in the embodiment of the present disclosure may be implemented in a software manner, and may also be implemented in a hardware manner. The name of the unit does not form the limitation of the unit in a certain case.

The above functions according to the present disclosure may be at least partially executed by one or more hardware logic components. For example, the hardware logic components of the demonstration type that may be used in a non-limiting manner includes: a Field Programmable Gate Array (FPGA), an Application Specific Integrated Circuit (ASIC), an Application Specific Standard Product (ASSP), a System On Chip (SOC), a Complex Programmable Logic Device (CPLD) and the like.

In the context of the present disclosure, a machine readable medium may be a tangible medium, and may contain or store a program used by the instruction execution system, apparatus or device or used in combination with the instruction execution system, apparatus or device. The machine readable medium may be a machine readable signal medium or a machine readable storage medium. The machine readable medium may include but be not limited to electronic, magnetic, optical, electromagnetic, infrared or semiconductor systems, apparatuses or devices, or any proper combination of the above contents. More specific examples of the machine readable storage medium may include one or more wire-based electrical connection, a portable computer disk, a hard disk, a Random Access Memory (RAM), a Read-Only Memory (ROM), an Erasable Programmable Read-Only Memory (EPROM or flash memory), an optical fiber, a Compact Disk-Readable Memory (CD-ROM), an optical storage device, a magnetic storage device, or any proper combination of the above contents.

According to one or more embodiments of the present disclosure, the present disclosure provides a data interaction method, including: displaying a video playing page, the video playing page displaying a shoe try-on control associated with target shoes; in response to a triggering operation on the shoe try-on control, starting a terminal camera to enter a try-on page of the target shoes, and controlling a first shoe model of the target shoes with a preset size to be worn on user's feet shot by the camera in the try-on page; and in response to a triggering operation for a target size in the try-on page, controlling a second shoe model of the target shoes with the target size to replace the first shoe model to be worn on the user's feet, wherein when the target size is larger than the preset size, the second shoe model is larger than the first shoe model.

According to one or more embodiments of the present disclosure, optionally, the data interaction method provided by the present disclosure further includes: in response to a triggering operation on a transparency adjusting control in the try-on page, controlling a transparency of the first shoe mold or the second shoe mold worn on the user's feet, thereby exposing the user's feet covered by the first shoe mold or the second shoe mold.

According to one or more embodiments of the present disclosure, optionally, in the data interaction method provided by the present disclosure, the transparency adjusting control includes a transparency adjusting sliding rod; and in response to the triggering operation on the transparency adjusting control, controlling the transparency of the first shoe mold or the second shoe mold worn on the user's feet includes: determining target transparency according to a position of an adjusting pointer on the transparency adjusting sliding rod; and controlling the transparency of the shoe mold worn on the user's feet to be the target transparency.

According to one or more embodiments of the present disclosure, optionally, the data interaction method provided by the present disclosure further includes: in response to a triggering operation on a personalized customization control in the try-on page, displaying at least one preset pattern; in response to a triggering operation on a target pattern, controlling the target pattern to be projected to the first shoe mold or the second shoe mold based on a PTM technology, the triggering operation on the target pattern being used for determining the selected target pattern from the at least one preset pattern.

According to one or more embodiments of the present disclosure, optionally, the data interaction method provided by the present disclosure further includes: in response to a preset operation, adjusting a projection position of the target pattern on the first shoe mold or second shoe mold; and in response to a triggering operation on an editing control, displaying an editing page of the target pattern, thereby enabling the user to edit the target pattern based on the editing page.

According to one or more embodiments of the present disclosure, optionally, the data interaction method provided by the present disclosure further includes: in response to a triggering operation on a release control in the try-on page, releasing the first shoe mold or the second shoe mold projected with the target pattern as a work.

According to one or more embodiments of the present disclosure, optionally, the data interaction method provided by the present disclosure further includes: in response to a triggering operation on an acquisition control in the try-on page, displaying an acquisition page of the target shoes, thereby enabling the user to acquire the target shoes based on the acquisition page.

According to one or more embodiments of the present disclosure, the present disclosure provides a data interaction apparatus, including: a first display module, configured to display a video playing page, the video playing page displaying a shoe try-on control associated with target shoes; a first try-on module, configured to in response to a triggering operation on the shoe try-on control, start a terminal camera to enter a try-on page of the target shoes, and control a first shoe model of the target shoes with a preset size to be worn on user's feet shot by the camera in the try-on page; and a second try-on module, configured to in response to a triggering operation for a target size in the try-on page, control a second shoe model of the target shoes with the target size to replace the first shoe model to be worn on the user's feet, wherein when the target size is larger than the preset size, the second shoe model is larger than the first shoe model.

According to one or more embodiments of the present disclosure, optionally, the data interaction apparatus provided by the present disclosure further includes: a control module, configured to in response to a triggering operation on a transparency adjusting control in the try-on page, control a transparency of the first shoe mold or the second shoe mold worn on the user's feet, thereby exposing the user's feet covered by the first shoe mold or the second shoe mold.

According to one or more embodiments of the present disclosure, optionally, in the data interaction apparatus provided by the present disclosure, the transparency adjusting control includes a transparency adjusting sliding rod; and the control module is specifically configured to determine target transparency according to a position of an adjusting pointer on the transparency adjusting sliding rod; and control the transparency of the shoe mold worn on the user's feet to be the target transparency.

According to one or more embodiments of the present disclosure, optionally, the data interaction apparatus provided by the present disclosure further includes: a second display module, configured to in response to a triggering operation on a personalized customization control in the try-on page, display at least one preset pattern; a projection module, configured to in response to a triggering operation on a target pattern, control the target pattern to be projected to the first shoe mold or the second shoe mold based on a PTM technology, the triggering operation on the target pattern being used for determining the selected target pattern from the at least one preset pattern.

According to one or more embodiments of the present disclosure, optionally, the data interaction apparatus provided by the present disclosure further includes: an adjusting module, configured to in response to a preset operation, adjust a projection position of the target pattern on the first shoe mold or second shoe mold; and an editing module, configured to in response to a triggering operation on an editing control, display an editing page of the target pattern, thereby enabling the user to edit the target pattern based on the editing page.

According to one or more embodiments of the present disclosure, optionally, the data interaction apparatus provided by the present disclosure further includes: a releasing module, configured to in response to a triggering operation on a release control in the try-on page, release the first shoe mold or the second shoe mold projected with the target pattern as a work.

According to one or more embodiments of the present disclosure, optionally, the data interaction apparatus provided by the present disclosure further includes: an acquisition module, configured to in response to a triggering operation on an acquisition control in the try-on page, display an acquisition page of the target shoes, thereby enabling the user to acquire the target shoes based on the acquisition page. According to one or more embodiments of the present disclosure, the present disclosure provides an electronic device, including:
one or more processors; and
a memory for storing one or more programs;
wherein the one or more programs, when executed by the one or more
processors, cause the one or more processors to implement any one of the abovementioned data interaction methods according to the present disclosure.

According to one or more embodiments of the present disclosure, the present disclosure provides a computer readable storage medium, storing a computer program thereon, wherein the program, when executed by a processor, implements any one of the abovementioned data interaction methods according to the present disclosure.

An embodiment of the present disclosure also provides a computer program product, which includes a computer program or instructions, and the computer program or instructions, when executed by a processor, implement the data interaction method as described above.

The above description is only a preferred embodiment of the present disclosure and an explanation of the technical principles used. Those skilled in the art should understand that the scope of disclosure referred to in the present disclosure is not limited to technical solutions formed by specific combinations of the aforementioned technical features, but also covers other technical solutions formed by arbitrary combinations of the aforementioned technical features or their equivalent features without departing from the aforementioned disclosed concept. For example, a technical solution formed by replacing the above features with (but not limited to) technical features with similar functions disclosed in the present disclosure.

Moreover, although each operation is depicted in a specific order, this should not be understood as requiring them to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features described in the context of a single embodiment can also be implemented individually or in any suitable sub combination in multiple embodiments.

Although the subject matter has been described in language specific to structural features and/or method logical actions, it should be understood that the subject matter limited in the attached claims may not necessarily be limited to the specific features or actions described above. On the contrary, the specific features and actions described above are only exemplary forms of implementing the claims.

1. A data interaction method, comprising:
displaying a video playing page, the video playing page displaying a shoe try-on control associated with target shoes;
in response to a triggering operation on the shoe try-on control, starting a terminal camera to enter a try-on page of the target shoes, and controlling a first shoe model of the target shoes with a preset size to be worn on user's feet shot by the camera in the try-on page; and
in response to a triggering operation for a target size in the try-on page, controlling a second shoe model of the target shoes with the target size to replace the first shoe model to be worn on the user's feet;
wherein when the target size is larger than the preset size, the second shoe model is larger than the first shoe model.

2. The method according to claim 1, further comprising:
in response to a triggering operation on a transparency adjusting control in the try-on page, controlling a transparency of the first shoe mold or the second shoe mold worn on the user's feet, thereby exposing the user's feet covered by the first shoe mold or the second shoe mold.

3. The method according to claim 2, wherein the transparency adjustment control comprises a transparency adjustment sliding rod; and
in response to the triggering operation on the transparency adjusting control, controlling the transparency of the first shoe mold or the second shoe mold worn on the user's feet comprises:
determining target transparency according to a position of an adjusting pointer on the transparency adjusting sliding rod; and
controlling the transparency of the shoe mold worn on the user's feet to be the target transparency.

4. The method according to claim 1, further comprising:
in response to a triggering operation on a personalized customization control in the try-on page, displaying at least one preset pattern; and
in response to a triggering operation on a target pattern, controlling the target pattern to be projected to the first shoe mold or the second shoe mold based on a PTM technology, the triggering operation on the target pattern being used for determining the selected target pattern from the at least one preset pattern.

5. The method according to claim 4, further comprising:
in response to a preset operation, adjusting a projection position of the target pattern on the first shoe mold or second shoe mold; and
in response to a triggering operation on an editing control, displaying an editing page of the target pattern, thereby enabling the user to edit the target pattern based on the editing page.

6. The method according to claim 4, further comprising:
in response to a triggering operation on a release control in the try-on page, releasing the first shoe mold or the second shoe mold projected with the target pattern as a work.

7. The method according to claim 1, further comprising:
in response to a triggering operation on an acquisition control in the try-on page, displaying an acquisition page of the target shoes, thereby enabling the user to acquire the target shoes based on the acquisition page.

8. A data interaction apparatus, comprising:
a first display module, configured to display a video playing page, the video playing page displaying a shoe try-on control associated with target shoes;
a first try-on module, configured to in response to a triggering operation on the shoe try-on control, start a terminal camera to enter a try-on page of the target shoes, and control a first shoe model of the target shoes with a preset size to be worn on user's feet shot by the camera in the try-on page; and
a second try-on module, configured to in response to a triggering operation for a target size in the try-on page, control a second shoe model of the target shoes with the target size to replace the first shoe model to be worn on the user's feet;
wherein when the target size is larger than the preset size, the second shoe model is larger than the first shoe model.

9. An electronic device, comprising:
one or more processors; and
a storage apparatus for storing one or more programs;
wherein the one or more programs, when executed by the one or more processors, cause the one or more processors to implement a data interaction method, comprising:
displaying a video playing page, the video playing page displaying a shoe try-on control associated with target shoes;
in response to a triggering operation on the shoe try-on control, starting a terminal camera to enter a try-on page of the target shoes, and controlling a first shoe model of the target shoes with a preset size to be worn on user's feet shot by the camera in the try-on page; and
in response to a triggering operation for a target size in the try-on page, controlling a second shoe model of the target shoes with the target size to replace the first shoe model to be worn on the user's feet,
wherein when the target size is larger than the preset size, the second shoe model is larger than the first shoe model.

10. A non-transient computer readable storage medium, storing a computer program thereon, wherein the program, when executed by at least one processor, implements the method according to claim 1.
